(19) United States
(12) Patent Application Publication
(10) Pub. No.: US 2025/0239679 A1
(43) Pub. Date: Jul. 24, 2025

(54) BATTERY SYSTEM WITH IMPROVED COOLING CIRCUIT

(71) Applicant: SAMSUNG SDI CO., LTD., Yongin-si (KR)

(72) Inventor: Eymen IPEK, Graz (AT)

(21) Appl. No.: 18/769,131

(22) Filed: Jul. 10, 2024

(30) Foreign Application Priority Data
Jan. 23, 2024 (EP) 24153402.3

(51) Int. Cl. H01M 10/655; H01M 10/613; H01M 10/625; H01M 10/6568

(52) U.S. Cl. CPC H01M 10/655; H01M 10/613; H01M 10/625; H01M 10/6568

(57) ABSTRACT

A battery system includes: a battery pack including a plurality of battery cells; and a cooling circuit including cooling channels for cooling the battery cells via cooling fluid flowing along the cooling channels in a flow direction. The cooling channels include cooling channel segments, each of which extends along and is thermally conductively connected to one of the battery cells. The cooling channel segments each have an upstream end at where the cooling fluid enters the cooling channel segment and a downstream end at where the cooling fluid leaves the cooling channel segment. The cooling channel segments are lined with a phase-change material (PCM) configured to melt and detach from the inner wall of the cooling channel segment when the corresponding battery cell overheats and to solidify and accumulate at the downstream end of the cooling channel segment to block the cooling fluid from leaving the cooling channel segment.

### CROSS-REFERENCE TO RELATED APPLICATION

The present application claims priority to and the benefit of European Patent Application No. 24153402.3, filed on Jan. 23, 2024, in the European Patent Office, the entire disclosure of which is incorporated herein by reference.

### BACKGROUND

### 1. Field

Aspects of embodiments of the present disclosure relate to a battery system with an improved cooling circuit.

### 2. Description of the Related Art

Recently, vehicles for transportation of goods and peoples have been developed that use electric power as a source for motion. Such an electric vehicle is an automobile that is propelled permanently or temporarily by an electric motor using energy stored in rechargeable (or secondary) batteries. An electric vehicle may be solely powered by batteries (a so-called Battery Electric Vehicle or BEV) or may include a combination of an electric motor and, for example, a conventional combustion engine (a so-called Plugin Hybrid Electric Vehicle or PHEV). BEVs and PHEVs use high-capacity rechargeable batteries, which are designed to provide power for propulsion over sustained periods of time.

A battery cell includes an electrode assembly including a positive electrode, a negative electrode, and a separator interposed between the electrodes. A solid or liquid electrolyte allows movement of ions between the electrodes during charging and discharging of the battery cell. The electrode assembly is located in (or is accommodated in) a casing and electrode terminals, which are positioned on the outside of the casing, establish an electrically conductive connection to the electrodes. The shape of the casing may be, for example, cylindrical or rectangular.

A battery module is formed of a plurality of battery cells connected together in series or in parallel. That is, the battery module may be formed by interconnecting the electrode terminals of the plurality of battery cells in an arrangement or configuration depending on a desired amount of power and to realize a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems often include a plurality of battery modules connected in series to provide a desired voltage.

A battery pack is a set of any number of (usually identical) battery modules or single battery cells. The battery modules, or the battery cells, may be connected in a series, parallel, or a series/parallel connection configuration to deliver the desired voltage and to provide the desired capacity and/or power density. Components of a battery pack include the individual battery modules and interconnects, which provide electrical conductivity between the battery modules.

A thermal management system is often employed to provide thermal control of the battery pack to safely use (or employ) the battery module by efficiently emitting, discharging, and/or dissipating heat generated from its rechargeable batteries. If the heat emission, discharge, and/or dissipation is insufficiently performed, temperature deviations may occur between respective battery cells, which may cause the battery module to no longer generate a desired (or designed) amount of power. In addition, an increase of the internal temperature can lead to abnormal reactions occurring therein, and thus, charging and discharging performance of the rechargeable battery deteriorates, and the life-span of the rechargeable battery is shortened.

Exothermic decomposition of cell components may lead to a so-called thermal runaway. Generally, thermal runaway refers to a process that is accelerated by increased temperature, in turn releasing energy that further increases temperature. Thermal runaway occurs in situations where an increase in temperature changes cell conditions in a way that causes a further increase in temperature, often leading to a destructive result. In rechargeable battery systems, thermal runaway is associated with strong exothermic reactions that are accelerated by temperature rise. In thermal runaway, the battery cell temperature rises incredibly fast, and the energy stored therein is released very suddenly. In extreme cases, thermal runaway can cause battery cells to explode and start a fire. In minor cases, thermal runaway can cause battery cells to be damaged beyond repair.

When a battery cell is heated above a critical temperature (typically above about 150° C.), the battery cell can transition into thermal runaway. Generally, temperatures outside of the safe region on either the low or high side may lead to irreversible damage to the battery cell and, therefore, may possibly trigger thermal runaway. Thermal runaway may also occur due to an internal or external short circuit of the battery or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in a cell housing (or casing) into the battery pack. The main components of the vented gas are H₂, CO₂, CO, electrolyte vapor, and other hydrocarbons. The vented gas is, therefore, flammable and potentially toxic. The vented gas also causes a gas-pressure increase inside the battery pack. In the worst case, the high temperatures lead to the process spreading to neighboring battery cells and fire in the battery pack. At this stage, the fire is hard to extinguish.

It is, therefore, important to ensure an efficient cell cooling. For such cell cooling, a battery system may include a cooling circuit with cooling channels that extend along a side of the battery cells, usually along a bottom side of the battery cells. The battery cells may transfer heat to a cooling fluid flowing along the cooling channels, thereby cooling the battery cells. During thermal runaway, the inside of an affected battery cell may reach excessive temperatures of up to about 1000° C., which may, in turn, lead to significant heating of the cooling fluid. As a result, the cooling fluid may reach temperatures that are so high that the cooling fluid heats up (rather than cools) battery cells downstream of the affected battery cell. This kind of convective thermal propagation may, in the worst case, lead to one or more of the downstream battery cells experiencing thermal runaway as well.

### SUMMARY

According to embodiments of the present description, a battery system with an improved cooling circuit exhibiting improved thermal runaway handling is provided.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery system includes a battery pack including a plurality of battery cells and a cooling circuit including cooling channels for cooling the battery cells via cooling fluid flowing along the cooling channels in a flow direction. The cooling channels include cooling channel segments, and each of the cooling channel segments extends along and is thermally conductively connected to one of the battery cells. The cooling channel segments each have an upstream end at where the cooling fluid enters into the cooling channel segment and a downstream end at where the cooling fluid leaves the cooling channel segment. The cooling channel segments are lined, at an inner wall thereof, with a phase-change material (PCM) that is configured to melt and detach from the inner wall when the battery cell to which the cooling channel segment is thermally conductively connected to overheats, to be carried along the flow direction by the cooling fluid, and to solidify and accumulate at the downstream end of the cooling channel segment to block the cooling fluid from leaving the cooling channel segment.

According to an embodiment of the present disclosure, the cooling channel segments may each include a constriction at their downstream end for facilitating the blocking of the cooling fluid from leaving the cooling channel segment.

According to an embodiment of the present disclosure, the inner wall of the cooling channel segments lined with the PCM may be the inner wall closest to the battery cell the cooling channel segment extends along and is thermally conductively connected to.

According to various embodiment of the present disclosure, the PCM may have a melting point between about 70° C. and about 105° C., between about 80° C. and about 105° C., or about 80° C.

According to an embodiment of the present disclosure, the PCM may be a coating.

According to an embodiment of the present disclosure, the alloy may be at least one of bismuth-indium (BiIn), bismuth indium tin (BiInSn), aluminum-silicon (AlSi), aluminum-magnesium (AlMg), or gallium-aluminum-arsenide (GaAlAs).

Another embodiment of the present disclosure provides an electric vehicle including the battery system as described above.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic bottom view of a battery system according to an embodiment.

FIGS. 2a and 2b are schematic cross-sectional view of one of the battery cells and a corresponding cooling channel segment of the battery system shown in FIG. 1.

FIGS. 3a and 3b are schematic cross-sectional view corresponding to those of FIGS. 2a and 2b a PCM blocking the cooling channel segment.

FIG. 4 is a schematic bottom view of the battery system shown in FIG. 1 illustrating the cooling flow being rerouted due to a PCM blocking the cooling channel segment of one of the battery cells.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure may, however, be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly. Herein, the terms “upper” and “lower” are defined according to the z-axis. For example, the upper cover is positioned at the upper part of the z-axis, and the lower cover is positioned at the lower part thereof.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to embodiments of the present disclosure, a battery system includes a plurality of battery cells. The battery system may include a housing accommodating the battery cells. The battery cells may be arranged into battery packs, and in each battery pack, the battery cells may be interconnected via electrical connectors, such as busbars, contacting respective electrode/cell terminals of the battery cells. The battery cells are arranged to form one or more battery packs. In a battery pack, the battery cells are electrically interconnected in a series and/or in parallel. Multiple of the battery cell within a battery pack may form a battery module. Two or more of the battery modules may be stacked to form cell stacks. The battery cells may be, for example, prismatic or cylindrical cells. Each of the battery cells has a top side at an upper end of the battery cell and a bottom side at a lower end of the battery cell. The battery cells may each have a venting exit in a venting side of the battery cell, which may be the terminal side of the battery cells. The venting exits allow a venting gas stream to escape the battery cells during a thermal runaway. Venting valves may be provided at or in the venting exits. The venting side may be the top side and/or the bottom side of the battery cells. In other words, the venting exits may be provided at the top side and/or the bottom side of the battery cells.

The battery system further includes a cooling circuit for cooling the battery cells. The cooling circuit includes cooling channels for carrying a cooling fluid along a flow direction. The cooling circuit may include a supply line for supplying the cooling fluid to the cooling channels and a return line along which the cooling fluid may leave (or exit) the cooling channels. The cooling fluid may be actively pumped through the cooling circuit via, for example, an electric pump. The cooling channels include cooling channel segments that correspondingly extend along at least one side of one of the battery cells, for example, of exactly one of the battery cells. For example, the section of a cooling channel that extends along a battery cell may be understood as or referred to as the cooling channel segment of that battery cell. The cooling channel segments extend along the bottom sides of the respective battery cell. That is, the battery cells/packs are arranged on (or over) the cooling channels. One cooling channel segment may be provided for each battery cell. The cooling channel segments are each thermally conductively connected to the corresponding battery cells along which they extend. In other words, the cooling channel segments are arranged and configured to receive heat from their respective battery cell via conductive heat transfer, for example, via a cell housing of the battery cell. The cooling channel segments each have an upstream end through which the cooling fluid enters into the cooling channel segment and a downstream end for discharging or the exiting of the cooling from the cooling channel segment.

According to an embodiment, at least one of the cooling channel segments is lined with a phase-change material (PCM). In some embodiments, all of the cooling channel segments are lined with the PCM. The cooling channel segment being lined with the PCM means that the PCM is arranged or disposed at least at one inner wall of the cooling channel segment. For example, an inner wall closest to that battery cell the cooling channel segment extends along may be lined with the PCM. An inner wall means an inside wall of the cooling channel segment that delimits the cooling channel segment on the inside, for example, an inner wall that is in contact with the cooling fluid. In some embodiments, the cooling channel segment is completely lined with the PCM, that is, all of the inner walls are lined with the PCM.

The PCM is configured to melt and detach from the inner wall when the respective battery cell, to which the cooling channel segment is thermally conductively connected to, overheats. The PCM has a melting point that is exceeded when the respective battery cell overheats. Overheating means that the respective battery cell reaches a temperature that is higher (or substantially higher) than the regular operational temperature of the battery cell, for example, may be a temperature that the respective battery cell reaches (only) during a thermal runaway. The material of the PCM is chosen such that the PCM melts when the affected battery cell overheats, that is, when the affected battery cell experiences a thermal runaway. That is, the material of the PCM and, therefore, the melting point of the PCM, may be chosen depending on the cell chemistry because different cell chemistry may reach different temperatures during a thermal runaway. Also, the cell architecture may be considered when choosing the material of the PCM and, thus, the melting point thereof. For example, depending on the cell architecture and the cell chemistry, during a thermal runaway an outer surface of the affected battery cell may reach temperatures of about 250° C. The adjacent cooling channel segment is heated up by the outer surface of the battery cell and the PCM by the cooling channel segment. In such an embodiment, the PCM may then be chosen to have a melting point of about 80° C. as this temperature should be exceeded during thermal runaway. The detached PCM is carried along the flow direction, by the cooling fluid, through the cooling channel segment and solidifies and accumulates at the downstream end of the cooling channel segment, thereby blocking the cooling fluid from leaving the cooling channel segment. This stops heat propagation via the cooling fluid, as described in more detail below.

If a battery cell of the battery system experiences a thermal runaway, it heats up excessively and, thus, overheats. A battery cell experiencing a thermal runaway is also referred to as an affected battery cell. As mentioned previously, the temperature inside the affected battery cell may reach up to about 1000° C. depending on the cell chemistry. Therefore, a large amount of heat energy is transferred conductively from the affected battery cell, via a cell housing, to the cooling channel segment. As a result, the cooling channel segment and, thus, the PCM at the inner wall of the cooling channel segment are heated up. In such a case, the PCM reaches a temperature that is higher than its melting point such that the PCM melts and, consequently, detaches from the inner wall of the cooling channel segment. The cooling liquid flowing along the cooling channel segment the PCM has detached from carries the detached PCM with it along the flow direction. The cooling liquid also cools the detached PCM so that it again transitions in phase, that is, it solidifies. In other words, the liquified and detached PCM is cooled below its melting point due to heat transfer with the cooling fluid and the increased distance from the affected battery cell. The material of the PCM and, thus, its melting point is chosen such that this re-solidifying happens within the cooling channel segment. The solidified PCM then accumulates at the downstream end of the cooling channel segment, thereby blocking the exit of the cooling channel segment, for example, blocking the cooling fluid from leaving the cooling channel segment. The re-solidified PCM may form a single block or a variety of smaller lumps/chunks that clog the cooling channel segment and, thus, the respective cooling channel. Therefore, the affected battery cell has limited access to the cooling fluid as the respective cooling channel segment presents a dead end to the cooling liquid. Due to this blocking, the cooling fluid is rerouted to bypass the affected battery cell and, thus, the heat source. As a result, the cooling fluid is not heated up as much by the affected battery cell and does not present a risk for the other (or downstream) battery cells. For example, battery cells arranged subsequently in the flow direction, that is, downstream of the affected battery cell, will not be heated up by the cooling fluid. Thereby, convective heat propagation from the affected battery cells via the cooling fluid is reduced or prevented. In this manner, improved thermal runaway handling is achieved.

According to an embodiment, the cooling channel segments each include a constriction at their downstream end for facilitating the blocking of the cooling fluid to prevent it from leaving the cooling channel segment. The constriction may be a reduction in cross-sectional area of the cooling channel segment. For example, an inner wall of the cooling channel segment may include a protruding element protruding from the inner wall into the cooling channel segment. For example, at least two opposite inner walls of the cooling channel segment may include such protruding elements. Such a constriction facilitates accumulation of the re-solidified PCM. In other words, such a constriction forms an obstruction within the cooling channel segment at where the detached and re-solidified PCM may accumulate. This ensures that the cooling channel segment of the affected battery cell is promptly blocked after the affected battery cell enters thermal runaway.

According to an embodiment, the inner wall of the cooling channel segments lined with the PCM is the inner wall closest to the battery cell along which the cooling channel segment extends and to which it is thermally conductively connected. This inner wall will heat up first after the affected battery cell enters the thermal runaway because it is closest to the affected battery cell. Thus, providing the PCM at least at this inner wall may ensure timely heating up of the PCM and, thus, block the cooling channel segment as described above.

According to an embodiment, the PCM has a melting point, that is, a melting temperature, between about 70° C. and about 105° C., between about 80° C. and about 105° C. and, in one embodiment, the PCM has a melting point of about 80° C. As described above, the melting point may vary (or may be selected) depending on the cell chemistry. Also, the cell architecture may be considered when choosing the material of the PCM and, thus, its melting point. For example, depending on the cell architecture and the cell chemistry, during a thermal runaway, an outer surface of the affected battery cell may reach temperatures of about 250° C. The adjacent cooling channel segment is heated up by the outer surface of the battery cell, and the PCM is heated by the cooling channel segment. The PCM may be chosen to have a melting point of about 80° C. because this temperature should be (or is expected or anticipated to be) exceeded during thermal runaway. The melting point of the PCM should be low enough to melt at the temperatures the cooling channel segment experiences during a thermal runaway of its respective battery cell but high enough to prevent melting of the PCM during regular operation. For example, a regular operational temperature of the cooling fluid may be about 45° C. and at most about 55° C. in warmer climates. Considering these factors, the above-mentioned temperature ranges, for example, the temperature of about 80° C., as the melting point are well-suited for ensuring that the PCM melts at the temperatures the cooling channel segment experiences during a thermal runaway of the battery cell the cooling channel segment extends along and is thermally coupled to but high enough to prevent melting of the PCM during regular operation.

According to an embodiment, the PCM is a coating. That is, the PCM may be coated to the inner wall(s) of the cooling channel segments. The PCM may be prepared as a solution and applied to the inner wall(s). This allows for a particularly efficient provision of the PCM.

According to an embodiment, the PCM is an alloy. According to an embodiment, the alloy is one of bismuth-indium (BiIn), bismuth indium tin (BiInSn), aluminum-silicon (AlSi), aluminum-magnesium (AlMg), and gallium-aluminum-arsenide (GaAlAs). These alloys may be suitable for use as the PCM because they may have melting points in the above-mentioned suitable ranges, for example, a melting point of about 80° C.

Embodiments of the present disclosure also provide an electric vehicle including a battery system according to the present disclosure.

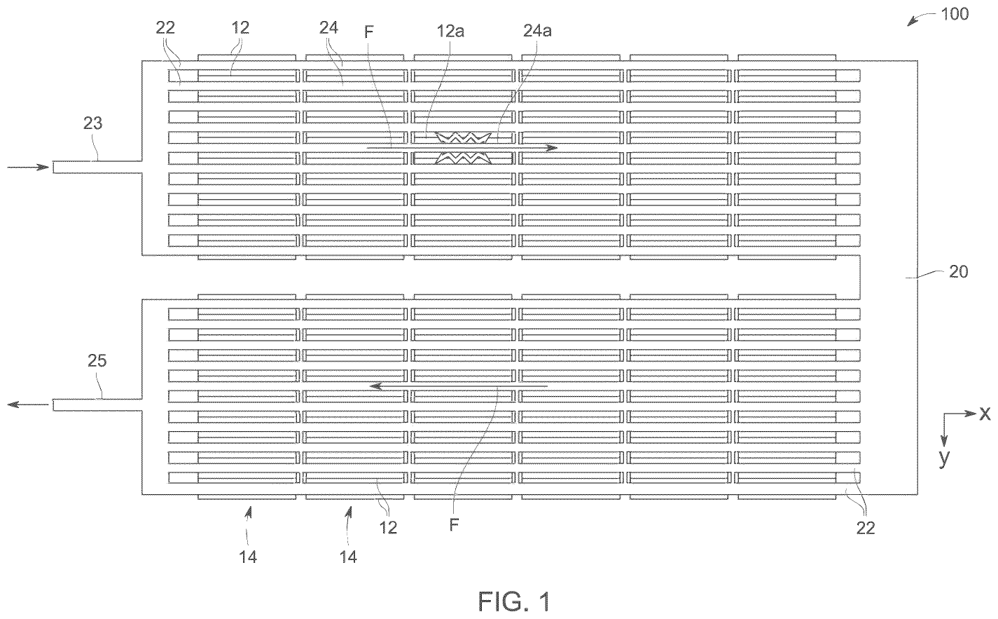

FIG. 1 is a bottom view schematically illustrating a battery system 100 according to an embodiment of the present disclosure. The battery system 100 includes a plurality of battery cells 12. The battery cells 12 are electrically interconnected to form multiple battery packs 14. The battery system 100 further includes a cooling circuit 20 including cooling channels 22, which extend along a bottom side of the battery cells 12, for cooling the battery cells 12. Cooling fluid enters the cooling circuit 20 via a supply line 23, flows through the cooling channels 22 along a flow direction F, and leaves (or exits) the cooling circuit 20 via a return line 25. For better readability, only some of the battery cells 12 and only some of the cooling channels 22 are indicated by reference numerals.

The cooling channels 22 include cooling channel segments 24. Each of the cooling channel segments 24 extends along (e.g., alongside) the bottom of one of the battery cells 12 and is thermally conductively connected to the one battery cell 12. For example, the section of a cooling channel 22 that extends along the battery cells 12 at their bottom side can be understood as, or may be referred to as, a cooling channel segment 24 configured to cool the corresponding battery cell 12. Heat may be transferred from the battery cell 12, for example, in case of a thermal runaway of the battery cell, via a cell housing of the battery cell 12 to the corresponding cooling channel segment 24.

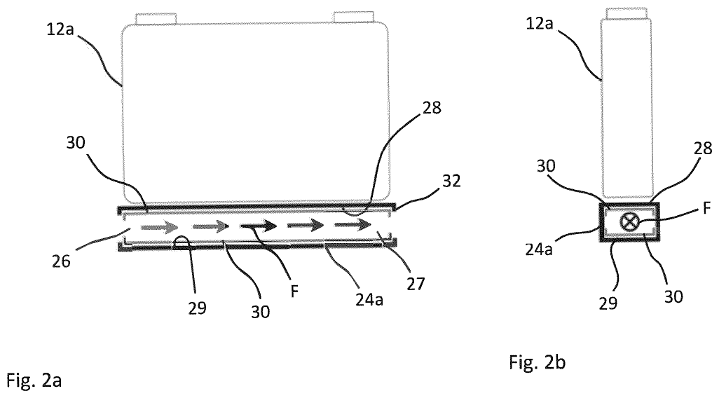

FIGS. 2a and 2b show different cross-sectional views of a battery cell 12a from among the plurality of battery cells 12 shown in FIG. 1. FIG. 2a is a cross-sectional view taken along a length of the battery cell 12a (i.e., along the x-axis as shown in FIG. 1), and FIG. 2b is a cross-sectional view taken along a width of the battery cell 12a (i.e., along the y-axis as shown in FIG. 1).

Referring to FIGS. 2a and 2b, a cooling channel segment 24a from among the cooling channel segments 24 shown in FIG. 1 extends along the bottom side of the battery cell 12a. The cooling channel segment 24a has an upstream end 26 and a downstream end 27. The cooling fluid enters the cooling channel segment 24a at the upstream end 26, flows through the cooling channel segment 24a along the flow direction F, and leaves the cooling channel segment 24a at the downstream end 27.

The cooling channel segment 24a has a constriction 32 at its downstream end 27 (see, e.g., FIG. 2a). The constriction 32 may be an area of the cooling channel segment 24a that has a reduced cross-sectional area.

The cooling channel segment 24a is lined with a phase-change material (PCM) 30, which is schematically shown in the drawings. The PCM 30 may be applied to inner walls 28, 29 of the cooling channel segment 24a as a coating. As shown in FIGS. 2a and 2b, the PCM 30 is formed on (or provided on) the inner wall 28, which is closest to the battery cell 12a that the cooling channel segment 24a is thermally conductively connected to. Also, in the illustrated embodiment, the PCM 30 is also provided on the opposite inner wall 29. The entire inner surface of the cooling channel segment 24a, that is, all of the inner walls of the cooling channel segment 24a, may be provided with the PCM 30. Thus, the cooling channel segment 24a may be completely lined with the PCM 30. The PCM 30 may have a melting point of, for example, about 80° C.

During regular operation, the temperature of the cooling fluid is about 45° C. and, at the most, about 60° C. in warm climates. During such regular operation, the PCM 30 is in solid form and is attached to the inner walls 28, 29 of the cooling channel segment 24a, which allows the cooling fluid to flow through the cooling channel segment 24a as described above. This is shown in FIGS. 2a and 2b.

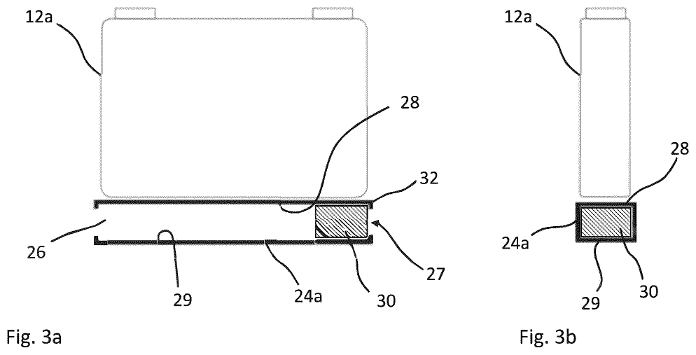

In case of a thermal runaway occurring inside the battery cell 12a, the affected battery cell 12a heats up excessively and, thereby, transfers heat conductively to the cooling channel segment 24a. For example, during such a thermal runaway, the battery cell 12a may reach a surface temperature of about 250° C. This heats up the adjacent cooling channel segment 24a, in other words, the inner walls 28, 29, which are coated with the PCM 30. Thereby, the melting point of the PCM 30, for example, about 80° C., is exceeded even though the PCM 30 is cooled by the flowing cooling liquid. This causes the PCM 30 to melt such that the PCM 30 detaches from the inner walls 28, 29 of the cooling channel segment 24a and is carried by the flow of cooling liquid along the flow direction F towards the downstream end 27 of the cooling channel segment 24a. During this process (e.g., after being detached from the inner walls 28, 29), the detached PCM 30 is cooled such that it solidifies again (e.g., due to heat transfer to the cooling fluid and the increased distance from the affected battery cell 12a). The solidified PCM 30 then accumulates at the downstream end 27 of the cooling channel segment 24a at the constriction 32, thereby blocking the cooling fluid from leaving the cooling channel segment 24a, as shown in, for example, FIGS. 3a and 3b.

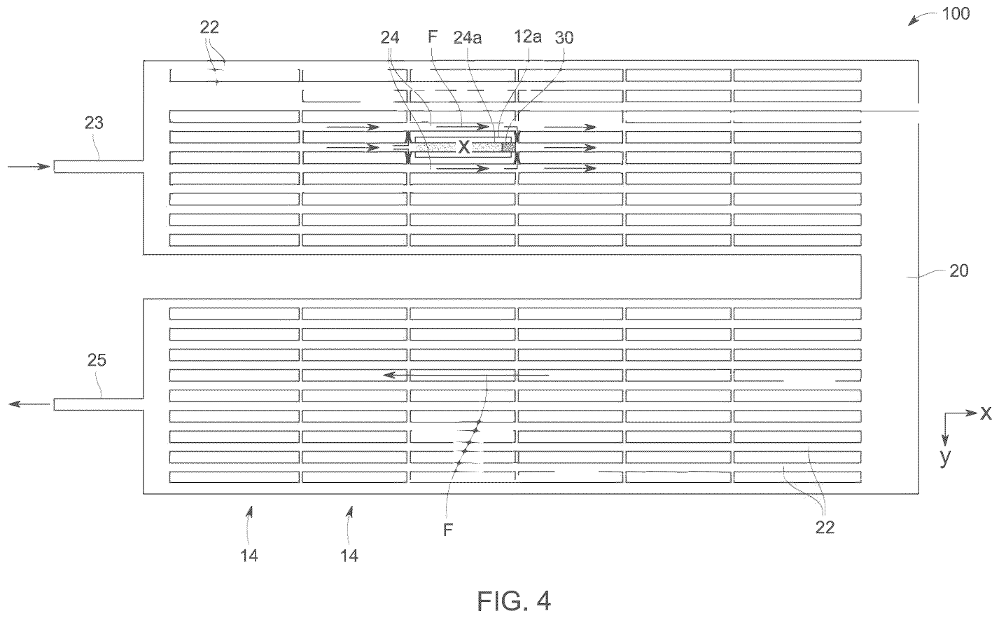

As a result of the solidified PCM 30 blocking the cooling fluid from flowing through the cooling channel segment 24a corresponding to the affected battery cell 12a, the flow of cooling fluid through the cooling circuit 20 is redirected or rerouted through the adjacent cooling channel segments 24 as indicated by the arrows in FIG. 4. Thus, the flow of cooling liquid circumvents the affected battery cell 12a. This avoids excessive heating up of the cooling liquid and, thus, prevents downstream battery cells 12 from being heated up, rather than cooled, by the cooling liquid. Therefore, convective heat propagation via the cooling liquid to further battery cells 12 is prevented, and the thermal runaway event may be contained. In FIG. 4, the battery cells 12 are not shown for better readability.

In some embodiments, the PCM and the constriction as described above are provided in or to each cooling channel segment 24 of every battery cell 12, for example, to all of the cooling channel segments 24, but the present disclosure is not limited thereto.

### Some Reference Symbols

12 battery cells
12a affected battery cell
14 battery packs
20 cooling circuit
22 cooling channels
23 supply line
24 cooling channel segments
24a cooling channel segment of affected battery cell
25 return line
28 inner wall closest to affected battery cell
29 opposite inner wall
30 PCM
32 constriction
100 battery system
F Flow direction

What is claimed is:

1. A battery system comprising:
a battery pack comprising a plurality of battery cells; and
a cooling circuit comprising cooling channels for cooling the battery cells via cooling fluid flowing along the cooling channels in a flow direction, the cooling channels comprising cooling channel segments, each of the cooling channel segments extending along and being thermally conductively connected to one of the battery cells, the cooling channel segments each having an upstream end at where the cooling fluid enters into the cooling channel segment and a downstream end at where the cooling fluid leaves the cooling channel segment,
wherein the cooling channel segments are lined, at an inner wall thereof, with a phase-change material (PCM) configured to melt and detach from the inner wall when the battery cell to which the cooling channel segment is thermally conductively connected to overheats, to be carried along the flow direction by the cooling fluid, and to solidify and accumulate at the downstream end of the cooling channel segment to block the cooling fluid from leaving the cooling channel segment.

2. The battery system as claimed in claim 1, wherein the cooling channel segments each have a constriction at their downstream end for facilitating the blocking of the cooling fluid from leaving the cooling channel segment.

3. The battery system as claimed in claim 1, wherein the inner wall of the cooling channel segments lined with the PCM is the inner wall closest to the battery cell the cooling channel segment extends along and is thermally conductively connected to.

4. The battery system as claimed in claim 1, wherein the PCM has a melting point between in a range between 70° C. and 105° C.

5. The battery system as claimed in claim 1, wherein the PCM has a melting point between in a range between 80° C. and 105° C.

6. The battery system as claimed in claim 1, wherein the PCM has a melting point of 80° C.

7. The battery system as claimed in claim 1, wherein the PCM is a coating.

8. The battery system as claimed in claim 1, wherein the PCM is an alloy.

9. The battery system as claimed in claim 8, wherein the alloy is at least one of bismuth-indium, bismuth indium tin, aluminum-silicon, aluminum-magnesium, or gallium-aluminum-arsenide.

10. An electric vehicle comprising the battery system as claimed in claim 1.
